(19) United States
(12) Patent Application Publication
(10) Pub. No.: US 2021/0014576 A1
(43) Pub. Date: Jan. 14, 2021

(54) VIRTUAL REALITY IMAGE PROVIDING SYSTEM USING VIRTUAL REALITY EXPERIENCE DEVICE

(71) Applicant: UNIVR CO., LTD., Daejeon (KR)

(72) Inventor: Tae Jin KWAK, Daejeon (KR)

(21) Appl. No.: 16/630,911

(22) PCT Filed: Apr. 18, 2019
(86) PCT No.: PCT/KR2019/004710

§ 371 Date: Jan. 14, 2020

(30) Foreign Application Priority Data
Jul. 13, 2018 (KR) 10-2018-0081655

(51) Int. Cl. H04N 21/81; H04N 21/436; H04N 21/414; H04N 21/41; H04N 21/854; H04N 21/845

(52) U.S. Cl. CPC H04N 21/816; H04N 21/43615; H04N 21/8456; H04N 21/4122; H04N 21/854; H04N 21/41407

(57) ABSTRACT

A virtual reality image providing system using a virtual reality experience device, includes: a virtual reality image providing server generating a virtual reality editing image including virtual reality experience information inserted at a specific point or a specific area of a virtual reality image; a mobile terminal receiving the virtual reality editing image from the virtual reality image providing server and reproducing the received virtual reality editing image; and a VR repeater receiving virtual reality experience information from the mobile terminal and delivering the received virtual reality experience information to a virtual reality experience device.

### BACKGROUND

The present invention relates to a virtual reality image providing system, and more particularly, to a virtual reality image providing system using a virtual reality experience device capable of receiving virtual reality sensory information inserted into a virtual reality image through the virtual reality experience device.

In the related art, provided are a production device for producing a virtual reality (VR) image and a VR device for experiencing the virtual reality image. For example, in the related art, as disclosed in Korean Patent Unexamined Publication No. 10-2018-0010891, a VR device for vividly experiencing a specific site at 360 degrees is provided.

However, the VR device in the related art as a head mounted display (HMD) is low in purchase price, but a user just watches a three-dimensional image only with eyes, and as a result, it is difficult for the user to feel a real experience using five senses in a specific scene of the image.

Further, in the related art, in only a part of a large theater, the user can watch the virtual reality image and experience the specific scene.

### SUMMARY OF THE INVENTION

In order to solve the problem, the present invention has been made in an effort to provide a virtual reality image providing system using a virtual reality experience device, in which a mobile terminal receives a virtual reality editing image from a virtual reality image providing server and reproduces the received virtual reality editing image and a VR repeater receives virtual reality experience information from the mobile terminal and delivers the received virtual reality experience information to the virtual reality experience device.

An exemplary embodiment of the present invention provides a virtual reality image providing system using a virtual reality experience device, which includes: a virtual reality image providing server generating a virtual reality editing image including virtual reality experience information inserted at a specific point or a specific area of a virtual reality image through an edition program; a mobile terminal executing an application for reproducing the virtual reality editing image received from the virtual reality image providing server; and a VR repeater receiving the virtual reality experience information from the mobile terminal and delivering the received virtual reality experience information to at least one virtual reality experience device, in which experience information inserted into the virtual reality image is provided to the virtual reality experience device.

The virtual reality image providing server may include the edition program and inserts the virtual reality experience information into a caption format and produce the virtual reality experience information in a caption file type.

The virtual reality image providing server may generate the virtual reality editing image and upload the generated virtual reality editing image to an image DB and provide the virtual reality editing image stored in the image DB to the mobile terminal through a real-time streaming or download scheme.

The VR repeater may be connected to the mobile terminal 1 to 1 to receive the virtual reality experience information from the mobile terminal and connected to the virtual reality experience device 1 to N to deliver the virtual reality experience information to the virtual reality experience device.

The VR repeater may include an input means receiving a reproduction control signal for reproduction control of the virtual reality editing image and transmit the reproduction control signal to the mobile terminal to remotely control the virtual reality editing image reproduced through the application.

The virtual reality experience information may include timing information of defining the specific point or area, a device index of defining a type of virtual reality experience device, and an operation value of defining an operation of the virtual reality experience device.

According to an exemplary embodiment of the present invention, a mobile terminal receives a virtual reality editing image from a virtual reality image providing server and reproduces the received virtual reality editing image and a VR repeater receives virtual reality experience information from the mobile terminal and delivers the received virtual reality experience information to the virtual reality experience device to provide a home VR VOD service.

### BRIEF DESCRIPTION OF THE DRAWINGS

FIG. 1 is a block diagram of a virtual reality image providing system according to the present invention.

FIG. 2 is a block diagram illustrating a detailed configuration of a virtual reality image providing server of FIG. 1.

FIG. 3 is a block diagram illustrating a detailed configuration of a VR repeater of FIG. 1.

FIG. 4 is a diagram illustrating an example of a virtual reality editing image generated by the virtual reality image providing server of FIG. 1.

FIG. 5 is a diagram for describing a data structure of virtual reality experience information included in a virtual reality editing image of FIG. 1.

### DETAILED DESCRIPTION OF THE PREFERRED EMBODIMENT

Hereinafter, exemplary embodiments will be described in detail below with reference to the accompanying drawings and contents described in the accompanying drawings, but the present invention is not restricted or limited by the exemplary embodiments.

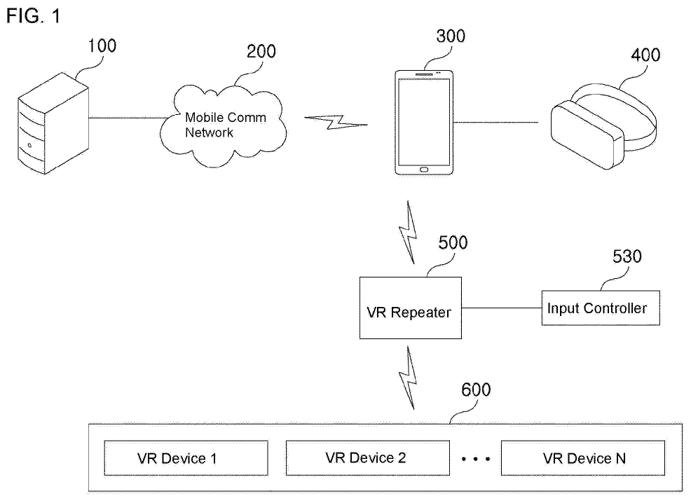

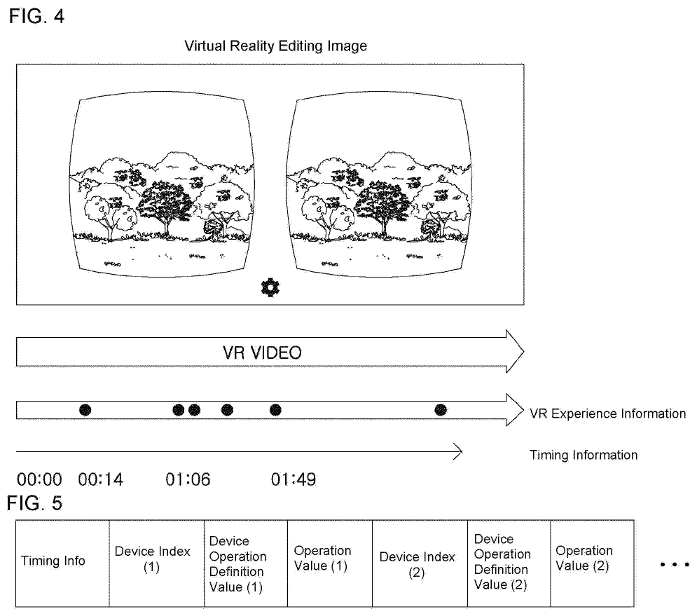

FIG. 1 is a block diagram of a virtual reality image providing system according to the present invention, FIG. 4 is a diagram illustrating an example of a virtual reality editing image generated by the virtual reality image providing server of FIG. 1, and FIG. 5 is a diagram for describing a data structure of virtual reality experience information included in a virtual reality editing image of FIG. 1.

The virtual reality image providing system according to the present invention which is used for providing a virtual reality image for personalized leisure contents due to an increase in one person household includes a virtual reality image providing server 100, a mobile communication network 200, a mobile terminal 300, a VR repeater 500, and a virtual reality experience device 600.

The virtual reality image providing server 100 generates a virtual reality editing image including one or more virtual reality experience information inserted at a specific point or a specific area of an image for virtual reality experience for an image viewer in multiple virtual reality images and transmits the generated virtual reality editing image to the mobile terminal 300 connected through the mobile communication network 200. The virtual reality editing image means an image including one or more virtual reality experience information inserted at the specific point or area of the image for the virtual reality experience for an image viewer in a virtual reality image which may be viewed by the mobile terminal 300 mounted on the head mounted display 400.

Further, a transmission scheme of the virtual reality editing image may be a streaming scheme or a download scheme. For example, the virtual reality image providing server 100 provides a streaming URL to the mobile terminal 300 by an Http Live Streaming (HLS) scheme.

The mobile communication network 200 may be a mobile network for communication between the virtual reality image providing server 100 and the mobile terminal 300 and the virtual reality image providing server 100 may be connected to the mobile communication network 200 through an Internet network (not illustrated) and a network gateway (not illustrated).

The mobile terminal 300 executes an application for reproducing the virtual reality editing image received from the virtual reality image providing server 100 and s wirelessly connected to one or more virtual reality experience device 600 capable of experiencing a virtual reality in response to the virtual reality experience information and transmits the virtual reality experience information. The mobile terminal 300 may be, for example, a smart phone, a phablet phone, etc., insertable into or mountable on the head mounted display 400.

The application installed in the mobile terminal 300 may be initially installed through a download web page provided in connection with the virtual reality image providing server 100 and may reproduce a desired reality editing image by streaming or download and reproduce through membership and login.

The present invention may selectively provide the virtual reality image and editing image to a user through the application of the mobile terminal 300 and selectively provide the virtual reality image and editing image according to presence of the virtual reality experience device 600 or regardless of the presence and provide a selected image and satisfy a need of the user.

The mobile terminal 300 is inserted into or mounted on the head mounted display 400 to display the virtual reality editing image. In other words, here, the head mounted display 400 as a smart phone dedicated VR device on which the smart phone as the mobile terminal 300 is mounted may be, for example, Google cardboard, iOS cardboard, Samsung Gear VR, VR BOX, etc.

The VR repeater 500 is connected to the mobile terminal 300 1 to 1 to receive the virtual reality experience information from the mobile terminal 300 and connected to the virtual reality experience device 600 1 to N to deliver the virtual reality experience information to the virtual reality experience device 600. More specifically, the VR repeater 500 wirelessly connects the mobile terminal 300 and the virtual reality experience device 600 and the wirelessly connected mobile terminal 300 receives the virtual reality experience information included in the corresponding virtual reality editing image and transmits the received virtual reality experience information to the virtual reality experience device 600 at the time of reproducing the virtual reality editing image. The VR repeater 500 may use known wireless communication methods such as radio frequency (RF), Bluetooth, Zigbee, and near field communication (NFC) and may be Bluetooth-connected to the mobile terminal, for example, and connected through RF communication by considering compatibility and versatility of a plurality of virtual reality experience device 600. For example, the RF communication is long range (LoRa) communication. The VR repeater 500 may further include a signal conversion module (not illustrated) for mutually converting a Bluetooth signal and an RF signal.

According to the present invention, since various VR VOD is viewed in home through the mobile terminal 300, the mobile terminal 300 should receive an image including the virtual reality experience information from the virtual reality image providing server 100 and since the Bluetooth communication does not support communication of 1:N, the VR repeater 500 receives the virtual reality experience information from the mobile terminal 300 and delivers the received virtual reality experience information to the plurality of virtual reality experience devices 600.

According to the present invention, when the image is edited remotely from the virtual reality experience device 600, an unnatural representation may occur between virtual reality image reproduction and an operation of the virtual reality experience device, and as a result, a pilot simulation of an edited image and image re-edition are provided in a user experience environment in which the virtual reality experience device 600. More specifically, according to the present invention, an edited image generation unit 110 of the virtual reality image providing server 100 may provide the edited image in an image content provider edition environment and a program interlocking unit 520 of the VR repeater 500 may provide image edition in the user experience environment.

The VR repeater 500 is connected to the virtual reality image providing server 100 and the virtual reality experience device so as for a virtual reality image contents provider to reproduce the virtual reality editing image generated through an edition program and enable the pilot simulation which is previously experienced through the virtual reality experience device. In other words, the VR repeater 500 receives the virtual reality experience information through the edition program of the virtual reality image providing server 100 and transmits the virtual reality experience information to the virtual reality experience device to achieve the pilot simulation through the virtual reality experience device.

The VR repeater 500 includes an input means which may receive an input of the user so as to remotely control the virtual reality editing image being reproduced through the mobile terminal 300 and the input means receives a reproduction control signal for reproduction control of the virtual reality editing image. The input means may include an input controller 530 and a sensor unit 540. A detailed configuration of the VR repeater 500 will be described below.

The virtual reality experience device 600 may include a plurality of receivers (not illustrated) which is provided and each wirelessly receives the virtual reality experience information from the VR repeater 500 and provides a virtual reality experience service corresponding to the virtual reality experience information and an input means (not illustrated) receiving a user input for operating device on/off or setting. Each virtual reality experience device 600 may be directly worn by the image viewer or installed on a site in order to provide the virtual reality experience device and may be, for example, a device capable of experiencing the virtual reality, such as a vibrator, a 4D experience chair, a wind blower, a fog generator, a fragrance sprayer, an air sprayer, a bubble generator, a snow generator, etc., and the present invention is not limited thereto.

Here, the virtual reality experience information as an experience effect by senses including sense of touch, sense of smell, etc., except for sense of sight corresponding to a specific scene of the image reproduced when the virtual reality editing image is reproduced by the mobile terminal 300 means information which allows a motion control operation or vibration, water, fog, fragrance, bubbles, or snow to be generated on the site according to the type of virtual reality experience device 600.

The virtual reality experience information may be inserted at several specific points or areas at which the virtual reality image is reproduced and included in the virtual reality editing image as illustrated in FIG. 4.

Referring to FIG. 5, the virtual reality experience information includes timing information for defining a specific point or a specific area in the virtual reality editing image, a device index for defining the type of virtual reality experience device 600, and an operation value for defining the operation of the virtual reality experience device 600.

For example, specifically, when the vibrator is worn on a wrist, the virtual reality experience information included in the virtual reality editing image is received through the VR repeater 500 in the vibrator at the time of reproducing the virtual reality editing image in the mobile terminal 300 mounted on the head mounted display 400. The vibrator recognizes a code corresponding to the vibrator in the device index included in the virtual reality experience information and generates vibration on a wrist of a wearer if an operation value set in a specific reproduction time or a specific reproduction area corresponding to timing information included in the virtual reality experience information defines an On state.

Further, the virtual reality experience information may further include a device operation definition value according to characteristics of the virtual reality experience device 600. For example, in the case of the vibrator, a vibration strength or the number of vibrations may be separately set as the device operation definition value. Further, in the case of the 4D experience chair, up and down/forward and backward/left and right motion control, wind blower, and vibration functions may be all mounted and may be separately set for each function in the device operation definition value. Further, since a plurality of virtual reality experience information may be inserted every specific point or specific area in which the virtual reality editing image is reproduced, a plurality of device indexes, operation values, and device operation definition values may be generated as necessary.

The virtual reality providing server 100 may generate timing information by considering a transmission time when the virtual reality experience information is transmitted to the virtual reality experience device 600 and an operation occurrence time when the virtual reality experience device 600 operates through the experience information. The transmission time may include a time of converting the Bluetooth signal into the RF signal. For example, when the specific point of the image is 1 minute 30 seconds, the operation occurrence point of the experience information may be 1 minute 29.5 seconds considering a delay of the transmission time.

According to the present invention, the timing information considering the transmission time and the operation occurrence time is generated to generate an experience at the same timing as the image at the specific point and further enhance an immersion level of the user.

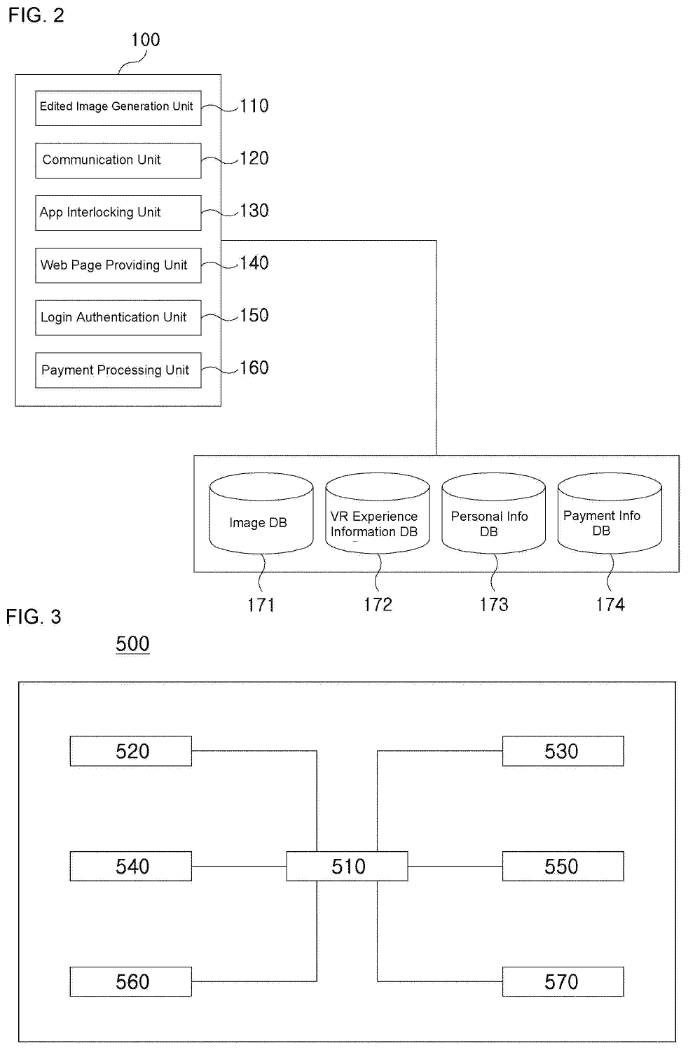

FIG. 2 is a block diagram illustrating a detailed configuration of a virtual reality image providing server of FIG. 1.

The virtual reality image providing server 100 further includes an edited image generation unit 110, a communication unit 120, an app interlocking unit 130, a web page providing unit 140, a login authentication unit 150, a payment processing unit 160, an image DB 171, a virtual reality experience information DB 172, a personal information DB 173, and a payment information DB 174 as illustrated in FIG. 2.

In the related art, when a movie is reproduced, a caption file such as srt in which a start time and an end time are set for each caption is together when reproducing the movie. According to the present invention, as if the start time and the end time are set for each caption like the srt caption in the related art, the movie may be produced by setting even the timing information of the virtual reality experience information in a caption file type together. More specifically, according to the present invention, synchronized experience information according to the image may be produced by inserting the virtual reality experience information into a caption format and reduction of complexity and production cost may be expected.

The edited image generation unit 110 may produce the virtual reality experience information in the caption file type by inserting the virtual reality experience information into the caption format. The edited image generation unit 110 may generate the virtual reality editing image including one or more virtual reality experience information inserted at the specific point or specific area of the image so as for the image viewer to experience the virtual reality in a virtual reality image which is an image to which the virtual reality is reflected. Further, the edited image generation unit 110 may provide an image edition program for inserting the virtual reality experience information into the virtual reality image. In other words, the virtual reality image contents provider inserts the virtual reality experience information into the specific points or specific areas of the virtual reality images through the image edition program to grant a desired virtual reality experience effect in the specific scene. The image edition program may be, for example, Adobe Premiere Pro, etc. Further, the virtual reality experience information included at the time of generating the virtual reality editing image may be included in a file produced in the caption file type and an extension name of the caption file may be, for example, *.HSI or *.SRT and the virtual reality editing image may be reproduced simultaneously when being reproduced by the mobile terminal 300.

The communication unit 120 is connected to the application installed in the mobile terminal 300 and provides a wireless communication protocol for transmitting necessary data including the virtual reality editing image to the mobile terminal 300.

The app interlocking unit 130 interlocks the application installed in the mobile terminal 300 to perform a membership procedure and login authentication of the mobile terminal 300 and provide a payment page when the virtual reality editing image requested by the mobile terminal 300 is charged and controls to transmit the virtual reality editing image paid by performing a payment process at the time of requesting payment through the payment page to the mobile terminal 300 through the communication unit 120.

The web page providing unit 140 provides multiple web pages required for providing the virtual reality editing image, which include a download web page to download the application to the mobile terminal 300 by the mobile terminal 300 through the app interlocking unit 130, an image list web page in which multiple virtual reality editing images are listed, a membership web page, and a payment web page for performing the payment process for the virtual reality editing image which is charged.

The login authentication unit 150 receives personal information for the membership at the time of requesting the membership to the mobile terminal 300 connected through the app interlocking unit 130 and processes the membership and performs login authentication based on the personal information at the time of requesting the login. The personal information may include an ID, a password, a subscriber name, a resident registration number, a cellular phone number, and a home address.

The payment processing unit 160 receives payment request information and performs payment processing for the corresponding image when requesting the virtual reality editing image which is charged from the mobile terminal 300 through the app interlocking unit 130.

The virtual reality image providing server 100 may generate the virtual reality editing image and upload the generated virtual reality editing image to the image DB 171 and provide the virtual reality editing image stored in the image DB 171 to the mobile terminal 300 through a real-time streaming or download scheme. The image DB 171 stores virtual reality editing images generated through the edited image generation unit 110 together with the virtual reality image.

The virtual reality experience information DB 172 stores the virtual reality experience information generated through the edition program according to a request of the virtual reality image contents provider. In other words, the virtual reality experience information DB 172 may make the stored virtual reality experience information into a database and manage the virtual reality experience information in order to use the virtual reality experience information at the time of producing the virtual reality editing image.

The personal information DB 173 stores membership personal information and the payment information DB 174 stores payment information generated by the payment process.

FIG. 3 is a block diagram illustrating a detailed configuration of a VR repeater of FIG. 1.

The VR repeater 500 further includes a control unit 510, a program interlocking unit 520, an input controller 530, a sensor unit 540, a communication module 550, a memory 560, and an input/output interface 570 as illustrated in FIG. 3.

The control unit 510 may control to transmit the virtual reality experience information transmitted from the mobile terminal 300 and the virtual reality experience information transmitted through the edition program included in the virtual reality image providing server 100 to the wirelessly connected virtual reality experience device by interlocking with the program interlocking unit 520 and perform the remote control by transmitting generation control signals of the input controller 530 and the sensor unit 540 to the wirelessly connected mobile terminal 300.

The program interlocking unit 520 is connected to the edition program used by the virtual reality image contents provider and connects the edition program and the virtual reality experience device by the communication module 550 to provide a program interface such as an application programming interface (API) so as to experience the virtual reality experience device. Further, the program interlocking unit 520 provides a program interface for the image edition in the user experience environment and the pilot simulation of the edited image by interlocking with the edition program.

The program interlocking unit 520 may perform the pilot simulation through the virtual reality experience device 600 in order to check whether the virtual reality experience information included in the virtual reality editing image is implemented as intended while the image contents provider edits the image in the same environment as the user through the edition program. Further, the program interlocking unit 520 provides a program interface so as to remotely control the virtual reality editing image reproduced by the application through the control unit 510 by interlocking even with the application installed in the mobile terminal 300.

The input controller 530 receives a reproduction control signal such as reproduction/pause/stop/fast forward/rewind of the virtual reality editing image which being reproduced from the mobile terminal 300 of the user and provides the reproduction control signal to the control unit 510 so as to enable remote control. The user may easily control the virtual reality editing image which is being reproduced without using an input unit (not illustrated) of the mobile terminal 300 or the head mounted display 400 through the input controller 530, thereby increasing user convenience.

The sensor unit 540 receives an operation signal of the user and converts the received operation signal into the reproduction control signal and provides the reproduction control signal to the control unit 510 so as to enable reproduction remote control through the operation of the user in addition to image remote control by direct button input of the input controller 530. The sensor unit 540 may include an operation sensor, a gyro sensor, or an acceleration sensor in order to receive the operation signal of the user.

The communication module 550 may provide a wireless communication program capable of performing interactive communication and transmit the virtual reality experience information included in the virtual reality editing image to the virtual reality experience device or transmit the reproduction control signal of the sensor unit 540 to the application of the mobile terminal 300 according to the request of the control unit 510.

The memory 560 may store the virtual reality experience information according to the request of the control unit 510 and store a command protocol for data transmission control such as the virtual reality experience information and a command program for the remote control including the reproduction control signal.

The input/output interface 570 may provide an interface for wired connection with a compatible external device (not illustrated) and provide, for example, a USE interface for wired connection of a wired/wireless compatible virtual reality experience device or wired connection of the virtual reality image providing server 100 in which the edition program is installed or a computer (not illustrated) of the virtual reality image contents provider.

According to the present invention, an edition environment of the image contents provider may be provided and the image contents provider may produce the virtual reality image into the virtual reality editing image including the experience information. More specifically, according to the present invention, as a previous process of a service providing the virtual reality image to the user, the edited image generation unit 110 of the virtual reality image providing server 100 may primarily provide the edited image in the content provider edition environment and the program interlocking unit 520 of the VR repeater 500 may secondarily provide image edition in the user experience environment. Further, according to the present invention, edition is made through primary edition and secondary verification to prevent unnatural representation between the virtual reality image reproduction and the operation of the virtual reality experience device.

According to the present invention, the edition environment may be provided to the image contents provider through the edition program of the edited image generation unit 110 and the image contents provider may produce a general virtual reality image into the virtual reality editing image including the experience information. Further, according to the present invention, a personal virtual reality on-demand video streaming service may be provided based on the virtual reality editing image including the experience information and the virtual reality on-demand video streaming service is provided, and as a result, the user may view VR VOD at low cost even at home or one person household without going to a large theater with a virtual experience facility. The present invention may be utilized for a home VR VOD service.

What is claimed is:

1. A virtual reality image providing system using a virtual reality experience device, comprising:
a virtual reality image providing server generating a virtual reality editing image including virtual reality experience information inserted at a specific point or a specific area of a virtual reality image through an edition program;
a mobile terminal executing an application for reproducing the virtual reality editing image received from the virtual reality image providing server; and
a VR repeater receiving the virtual reality experience information from the mobile terminal and delivering the received virtual reality experience information to at least one virtual reality experience device,
wherein experience information inserted into the virtual reality image is provided to the virtual reality experience device.

2. The virtual reality image providing system of claim 1, wherein the virtual reality image providing server includes the edition program and inserts the virtual reality experience information into a caption format and produces the virtual reality experience information in a caption file type.

3. The virtual reality image providing system of claim 1, wherein the virtual reality image providing server generates the virtual reality editing image and uploads the generated virtual reality editing image to an image DB and provides the virtual reality editing image stored in the image DB to the mobile terminal through a real-time streaming or download scheme.

4. The virtual reality image providing system of claim 1, wherein the VR repeater is connected to the mobile terminal 1 to 1 to receive the virtual reality experience information from the mobile terminal and connected to the virtual reality experience device 1 to N to deliver the virtual reality experience information to the virtual reality experience device.

5. The virtual reality image providing system of claim 1, wherein the VR repeater includes an input means receiving a reproduction control signal for reproduction control of the virtual reality editing image and transmits the reproduction control signal to the mobile terminal to remotely control the virtual reality editing image reproduced through the application.

6. The virtual reality image providing system of claim 1, wherein the virtual reality experience information includes timing information of defining the specific point or area, a device index of defining a type of virtual reality experience device, and an operation value of defining an operation of the virtual reality experience device.
